(19) United States
(12) Patent Application Publication
(10) Pub. No.: US 2026/0030591 A1
(43) Pub. Date: Jan. 29, 2026

(54) SYSTEM AND METHOD FOR PHOTOGRAPHIC INVENTORY AND SEARCHABLE CONTAINER-BASED ORGANIZATION

(71) Applicant: Paul Edward Moshe Modiano, MONTCLAIR, NJ (US)

(72) Inventor: Paul Edward Moshe Modiano, MONTCLAIR, NJ (US)

(21) Appl. No.: 19/281,089

(22) Filed: Jul. 25, 2025

Related U.S. Application Data
(60) Provisional application No. 63/676,010, filed on Jul. 26, 2024.

(51) Int. Cl. G06Q 10/087; G06V 20/50; G06V 20/70; H04L 9/40

(52) U.S. Cl. CPC G06Q 10/08743; G06V 20/50; G06V 20/70; H04L 63/10

(57) ABSTRACT

A system and method are provided for organizing and searching physical container inventories using hierarchical mapping and image-based indexing. The system receives an image of a container, associates the image with a text description of items contained therein, and tags the image with a container identifier, a site identifier, and a location within the site. The image and associated metadata are stored in a hierarchical inventory structure comprising nodes representing a building, rooms, and containers. A user interface enables keyword-based searching of the inventory and displays corresponding image results. Indoor navigation may be integrated to guide users from their current location to a selected container and may interface with home automation systems to control lighting along the navigation path. The dashboard interface allows nodes to be selectively hidden, unhidden, or modified, with modifications timestamped for inventory management.

### CROSS REFERENCE TO RELATED APPLICATIONS

This application claims the benefit of a U.S. Provisional Patent Appl. No. 63/676,010, filed on Jul. 26, 2024, which is incorporated herein by reference in its entirety.

### FIELD OF INVENTION

The present invention relates generally to inventory and organization systems. More particularly, it relates to a smartphone-based system for creating, maintaining, and sharing a photographic and text-based record of items stored within containers at physical locations.

### BACKGROUND

Keeping items organized is an important task in both residential and commercial environments. The primary objective of storing items in an orderly manner is to enable quick and convenient retrieval when needed. However, there are no standardized methods for organizing items in homes or commercial spaces; individuals typically rely on their own intuition and common knowledge to arrange items such as household goods, stationery, tools, emergency supplies, groceries, food products, and more. Professional services and guidance are also available to assist with organizing spaces effectively but such services are costly and not readily available.

Despite these efforts, a persistent problem remains, i.e., people often forget where a specific item has been stored. Moreover, items are frequently kept in enclosed spaces such as containers, bins, drawers, and cabinets, making it difficult to locate smaller objects. This challenge becomes more pronounced when a second person, someone not involved in the original organization process, needs to find an item. In emergency situations, a person unfamiliar with the home may struggle to locate essential items quickly.

This issue is particularly evident in vacation rental properties, where guests often face difficulty finding basic items. Property owners, in turn, find it challenging to communicate the complete inventory and the exact location of stored items to their guests.

There exists a need for a user-friendly and scalable system that enables individuals to create a searchable, visual inventory of containers and their contents and to share this information with others in a controlled manner.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, disclosed is a system and method for photographic inventory management of items at homes and commercial spaces. The items include household items, food items, grocery items, stationary items, emergency kit, first aid box, tools, and the like. The disclosed system and method provide for associating photographic images of containers with text-based descriptions of their contents, organized by location and site, allowing for searchable, shareable inventory management via a smartphone application. The system provides an interface for shareable inventory management that enables users to take a photo of a container and tag it with descriptive text of items in the container and location of the container. The system can store the tagged photographs including descriptive text as meta data in a predefined hierarchy in a database. The descriptive text is searchable using keywords and containers associated with the keywords can be shown.

In one aspect, the hierarchical order can be building→section→rooms/units→areas. The system allows sharing access to the database with different users. The access can be granted and revoked by the owner of the database to any user. Moreover, access for the limited time period can be granted. Also, the owner can set various permission levels for accessing the database, such as certain sections in the building may be prohibited for the user to access by the owner.

In one aspect, the system may provide for indoor navigation to a container, wherein turn-by-turn directions can be shown through the interface. The interface may show layout of the building for indoor navigation.

In one aspect, the AI module of the system may suggest or automatically apply labels based on prior inventory data or image analysis, thereby reducing user input requirements over time.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

FIGS. 3a-3g shows different screens of the interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The invention described pertains to a system and method for photographic inventory management of items. The disclosed system allows sharing inventory of items and their location within a building with different users. The creator of inventory may be referred to herein as an owner and the users of the inventory may be referred to as users. It is to be in noted that the owner can also use the disclosed system for locating an item, and in such a case, the owner becomes the user. Also, the user may be allowed to add or remove an item from the inventory with or without the approval of the owner.

The disclosed system can be used in any suitable building, such as residential homes, villas, commercial spaces, and the like wherein users can be benefited to quickly and easily locate an item, irrespective of the size of the item, and irrespective of who stored the item. Users merely using a smartphone can locate any item in known or unknown places. For example, users new at a vacation rentals can easily look for any needed item in the vacation rental through the disclosed system. The owner of the vacation rental may only have to share access to the disclosed system with the guests, avoiding any hassle of describing the place.

The inventory management is photographic in the sense that photographs of a container containing the respective items can be taken and stored. This allows one to quickly and easily locate the container in a room or cabinet. Additional photographs of the layout within the container or of the cabinet containing the container may also be added if needed.

Different types of items can be listed in the disclosed system, perhaps any item be added. For example, in a residential home, such as vacation rental, different household items that may be needed by a guest normally as well as in emergency situations can be included.

The disclosed system and method typically provide for associating a photographic image of a container with contents of the container and organized by location and site. The owners through their device can take photograph of a container and manually add list of items in the container. Any entry of items in the container can be removed or edited later. The disclosed system can further elaborate each entry, such that including its description and synonyms. The system allows searching for items with different names and in different languages. The system also intends to simplify manual entry by the use of AI models. The AI model can be trained to recognize ‘various items used in household and commercial buildings. The user can take an image of contents of the container and the AI module using the image recognition algorithms can auto populate the list of items in the container. The inventory along with the hierarchical organization data can be stored in a suitable database. The database containing the text-based descriptions of the items, organized by location and site, allows for searchable, shareable inventory management via a smartphone application.

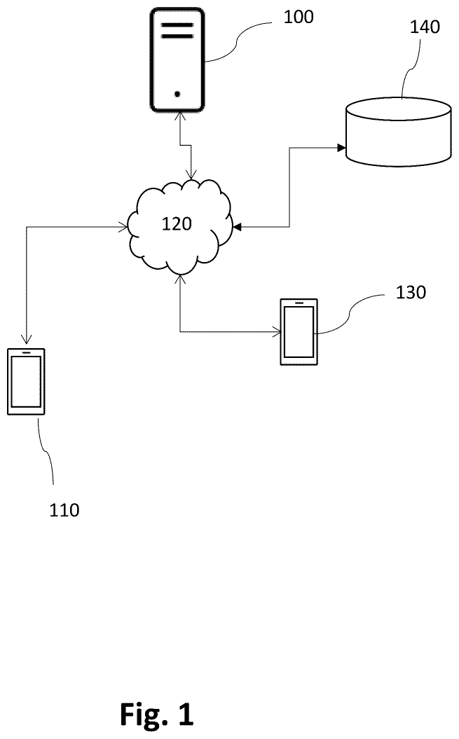

Referring to FIG. 1 is a block diagram showing an environment of the disclosed system 100. The system 100 can connect to an owner device 110 and a user device 130 through a network 120. Unless explicitly stated otherwise, both the owner and the user are also collectively referred to herein as ‘the user’. The term “user” as used herein, and throughout this disclosure, refers to an individual engaging a user device to interact with the system. The user device can be any computing device that includes a processor for processing instructions stored in memory. The user device can also include an input module for receiving input from the user. Such input can be in the form of a touch display, mouse, stylus, keyboard, touchpad, and the like. The user device may also include a display for presenting information to the user, for example, an LCD screen. The user device may also include a network circuitry for connecting to the network 120. Examples of the user device include a smartphone, a desktop computer, a laptop, a workstation, and the like. Preferably, the owner device may be a smartphone with a camera. The system 100 may also connect to a suitable database 140 for storing data.

The network may be any communication network known in the art, including a wired network, a wireless network, or a combination thereof. Examples of suitable communication networks include, but are not limited to, a local area network (LAN), a wide area network (WAN), a wireless WAN, a wireless LAN (WLAN), a metropolitan area network (MAN), a wireless MAN, a cellular data network, a cellular voice network, and the Internet. While, for illustrative purposes, FIG. 1 depicts a single network connecting multiple user devices, it should be understood by those skilled in the art that different user devices may connect to the system via various networks, and that a single user device may connect to the system through multiple networks concurrently or at different times. For example, a user device may access the system via both LAN and the Internet.

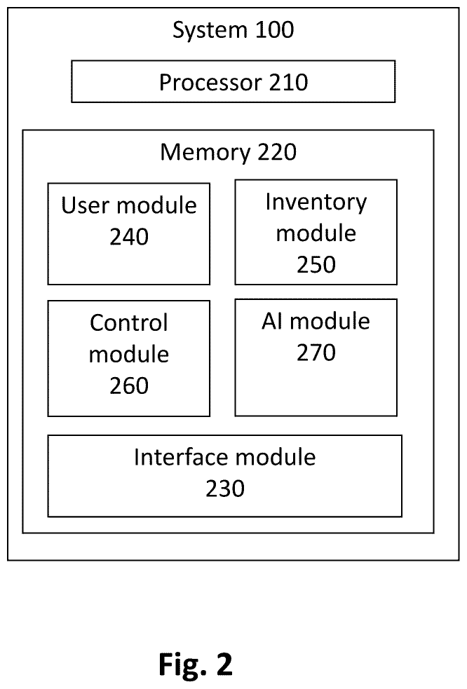

FIG. 2 shows the system 100 includes a processor 210 and a memory 220 operably coupled to the processor. The processor can be any logic circuitry that responds to, and processes instructions fetched from the memory. The memory may include one or more memory chips capable of storing data and allowing any storage location to be directly accessed by the processor. The memory can include modules according to the present invention for execution by the processor to perform one or more steps of the disclosed methodology.

The memory may include an interface module 230 which upon execution by the processor renders an interface on a user device; a user module 240 which upon execution by the processor may allow registration of individuals as a user of the system; an inventory module 250 which upon execution by the processor can allow creating inventory of items; a control module 260 which upon execution by the processor can allow sharing access to the inventory with different users; and an AI module 270 which upon execution by the processor can allow generating list of items in a container.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The system can be implemented in the form of servers, which include cloud servers. The servers can be placed in one location or geographically dispersed. Also, one or more steps of the disclosed methodology can be performed on one or more user devices without departing from the spirit of the disclosed subject matter. It is to be noted that certain functions of the system may be implemented on the user device. Also, the system can be implemented in the form of the user device. In such a case, the user device may communicate with the external database for storing and fetching information.

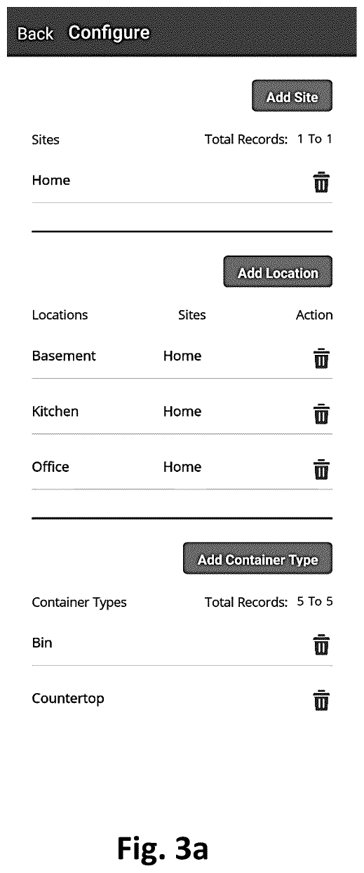

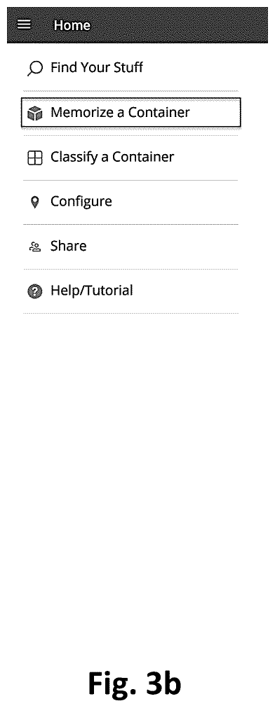

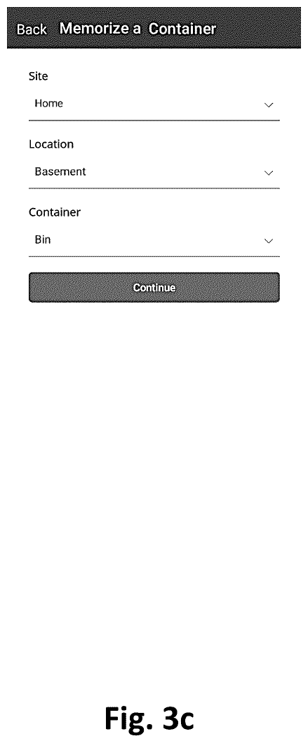

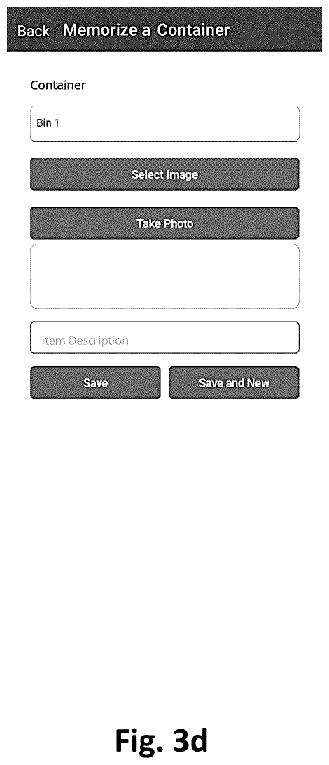

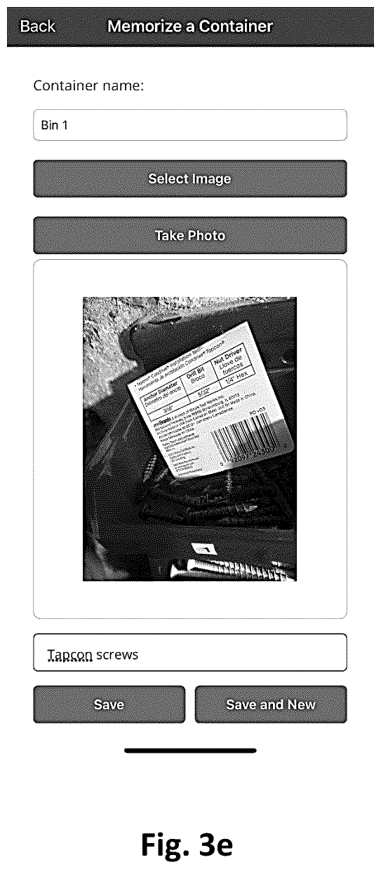

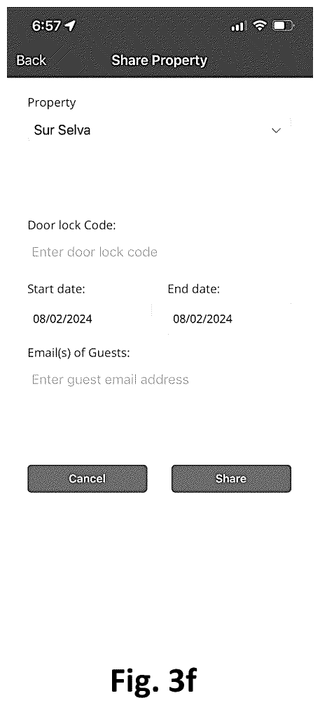

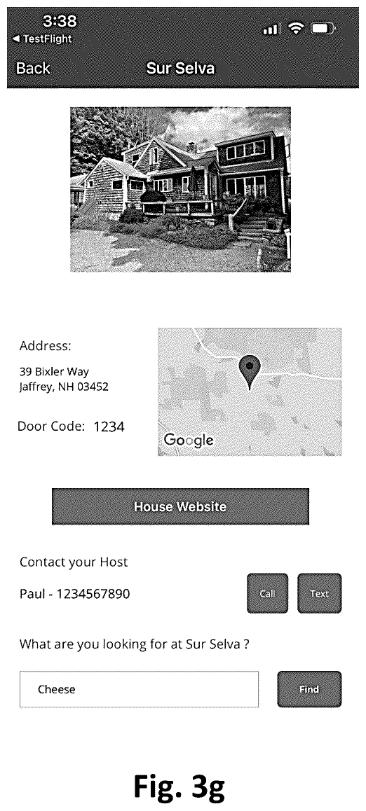

The interface provided by the interface module allows a user to interact with the disclosed system through a user device. The interface may include a series of screens, as shown in FIGS. 3a-3g, which in continuation can provide information as well as receive information from the user and execute one or more steps of the disclosed methodology. The interface can be dynamic and allows switching between sections, screens, pages, and the like quickly and easily. The interface can be provided as an application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100 and information can be received by system 100 from the user.

The user module 240 can generate login details to access the disclosed system securely. The login details may include at least a username and a password. The password can be an alphanumeric code, or biometric like a fingerprint, token, and the like. The user may have multiple login options, such as using an alphanumeric code or a fingerprint. Also, the use of multiple-factor authentication is within the scope of the present invention. The user can be provided with a login screen on the user device for accessing the disclosed system.

The system may render an interface on the user device to enable the user to take a photo of a container and tag it with descriptive text of items in the container and location of the container. Referring to FIG. 3a, which is the first screen of the interface that allows a user to enter a site, for example, the home for which inventory is being created. The user can enter the address of the site as well as a photograph of the site. The site can be any building, such as home, office, and the like. The user can add more than one site, for example, the user may have multiple vacation rentals. The user using the same interface can generate inventories for all the sites. Any created site can also be deleted by using the delete icon next to the label of the site.

Using the screen shown in FIG. 3a, for each site locations can be entered. For example, for home as the site, various locations in the home such as basement, kitchen, office, and the like can be added. The screen also allows the user to enter various container types, such as bin, countertop, and the like.

FIG. 3b shows a home screen of the interface which has several options, such as memorizing the container, classifying a container, configure share, and help. Memorizing the container may allow a user to specify the location of container. For example, FIG. 3c shows the bin type container located in basement of the site home. FIG. 3d shows the screen which is a continuation of the Memorizing the container. Through screen of FIG. 3d, the user can take a photo of the container or select an image from storage of the user device and associate the same with the container. The user can then save the entry of the container. The screen of FIG. 3e shows the same screen further showing photograph of the container. Below the photograph frame is a text frame, in which text entry can be made. The user can enter the list of items in the container in the text frame. The user can enter a comma-delimited list of items seen in the container. Pressing “save” icon can create a record including the image of the container and the descriptive text describing the items within. To add a new record, the user can click “Save and New” and repeat the process to add new containers. The user can add different containers for different locations on a site. The records are saved with hierarchy information. i.e., the hierarchy of site→location→container.

The control module 260 may allow a user share the photographic inventory of a site created using the inventory module 250, as described above, with other users. FIG. 3f shows a screen wherein the owner of a vacation rental can share the access to an inventory of a vacation rental with a guest. The user can also share a door lock through the screen. The access can be provided for limited duration. The email of guests can be entered through the screen. FIG. 3g shows a screen that may be presented to the guest. The system may also handle other aspects of vacation rentals, such as 39 location of property and contact address of the host. The share screen may be accessed through the home screen, shown in FIG. 3b. The share screen allows a host to select the site to share, specify a door unlock code, enter the name of the party that will attend, the date range during which they will have access to the database and the email addresses of the guests.

The control module can send email to the guests inviting them to download the interface and login. When they do, the server confirms their email address, recognizes them as guests, and puts up a guest screen for them showing the property, the address, a link to Google Maps, a means of contacting the hosts, and a textbox that they can enter anything that they are looking for. At bottom of the screen of FIG. 3g is shown a text box, in which free text entry can be made to enter keywords, and the control module can search the inventory with the keywords and determine the location of the item at the site in terms of location and bin. The control module can show the photograph of the bin so that the user can identify the container at the location and quicky could fetch the item. The control module upon receiving a query of items using keywords, can return a list showing the photos of all containers containing the sought-after item, the name of the container, and its location. The user can click any container and see the inside photograph of the container. The system can label each item in the inside photograph of the container and a labelled photograph can be displayed to the user.

In one aspect, the control module may allow setting permission on the data of the inventory data of a site. For example, certain locations at a site may be hidden from the guest users. The access to the inventory data can be granted and revoked by the owner of the database to any user. Moreover, access for the limited time period can be granted. Also, the owner can set various permission levels for accessing the database, such as certain sections in the building may be prohibited for the user to access by the owner.

The AI module 270 of the system may suggest or automatically create a list of items in a container based on prior inventory data or image analysis, thereby reducing user input requirements over time. The AI module can be trained using images of items and can use image recognition algorithm to recognize the items. Also, each item may be generalized by the AI module, i.e., a description of each item may be added that allows the respective item to be searched using different keywords and also in different languages. The data for a container may be stored as a metadata that links each container to a location and site.

The AI module can be trained with large number of photographs of items and photographs of the containers in which the respective items are generally stored, along with the matching text of the items. For example, screwdrivers in a toolbox. The AI model can then be used to automate the input of descriptions by the users. For that user, taking the photo of the junk drawer will allow the model to populate the description text automatically.

In certain embodiments, the disclosed system further integrates an indoor navigation module configured to assist a user in navigating to a selected container within a building. The indoor navigation module may generate navigation data based on pre-existing building plans, indoor positioning maps, or other methods known in the art for creating indoor navigation systems. The user interface provided by the interface module may enable a user to perform a keyword-based search for an item, wherein a corresponding container is displayed together with a photograph of the container and its associated location. The interface may further present an option to initiate navigation to the selected container. Upon selection, the interface module may generate and display a turn-by-turn navigation path from the user's current location to the container's location within the building. The current location of the user can be determined using suitable technologies, including but not limited to GPS, Wi-Fi triangulation, RFID, Bluetooth beacons, or other indoor positioning techniques. In some embodiments, the system additionally provides audio guidance to the user, enabling voice-assisted navigation to the container

In certain embodiments, the indoor navigation functionality may be integrated with home automation systems, including but not limited to automated lighting controls. For example, when the user enters a defined area within the building while navigating toward the container, the system may automatically activate lighting in that area to enhance visibility during the search or retrieval process. Conversely, when the user exits the area, the system may deactivate the lighting to conserve energy. In some implementations, upon detecting the user's entry into a room containing the selected container, the system may automatically turn on the room's lighting to assist the user in locating and accessing the container.

In certain embodiments, the interface module may present a dashboard screen on a user device associated with an owner or administrator of the system. The dashboard screen may display a hierarchical representation of the inventory, wherein the building serves as a top level node and subordinate nodes represent distinct areas or rooms of the building. Containers located within each room may be represented as further subordinate nodes branching from the corresponding room node. Each node and sub node in the hierarchy may be interactive, such that a selection of the node (e.g., via a clickable icon) presents a set of context specific actions applicable to that node. The available actions may include but are not limited to: Hide that conceals the selected node (e.g., a room or container) from other users; Unhide that restores visibility of a previously hidden node; and Modify that allows manipulation of the node, such as changing the location of a container or editing the contents associated with the container.

In some implementations, modifications to nodes may be timestamped to maintain a record of changes. Hidden nodes may be visually distinguished within the dashboard (e.g., via altered icon appearance) to indicate their hidden status.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for organizing and searching physical container inventories using a system comprising a processor and a memory, the method comprising:
receiving an image of a container;
associating the image with a text description of items in the container;
tagging the image with a container identifier, a location within a site, and a site identifier;
storing the image and associated metadata in a database in a form of hierarchical inventory comprising nodes representing a building, areas within the building, and containers;
enabling a user to search the hierarchical inventory using a text query; and
displaying image results corresponding to the text query.

2. The method of claim 1, further comprising:
inviting one or more users to access the hierarchical inventory with defined permissions and access durations.

3. The method of claim 1, further comprising:
automatically generating the text description of the items in the container from an internal photograph of the container and image recognition algorithms.

4. The method of claim 1, wherein the method further comprises:
integrating indoor navigation with the hierarchical inventory, wherein the indoor navigation is configured to guide a user to navigate from their current location to a selected container.

5. The method of claim 1, wherein the method further comprises:
rendering a search interface on a user device, wherein the search interface is configured to receive one or more keywords for the query and display corresponding results.

6. The method of claim of claim 3, wherein the method further comprises:
displaying the image of the container and the internal photograph of the container in the search results.

7. The method of claim 6, wherein the internal photograph is labeled with the items contained in the container.

8. The method of claim 4, further comprising:
interfacing the indoor navigation with a home automation system to automatically control lighting along a navigation path.

9. A system for organizing and searching physical container inventories, the system comprising:
a processor;
a memory coupled with the processor storing instructions that, when executed, cause the processor to:
receive an image of a container;
associate the image with a text description of items contained in the container;
tag the image with a container identifier, a location within a site, and a site identifier;
store the image and associated metadata in a database in the form of a hierarchical inventory comprising nodes representing a building, areas within the building, and containers;
enable a user to search the hierarchical inventory using a text query; and
display image results corresponding to the text query.

10. The system of claim 11, wherein the instructions are further configured to:
invite one or more users to access the hierarchical inventory with defined permissions and access durations.

11. The system of claim 11, wherein the instructions are further configured to:
automatically generate the text description of the items in the container from an internal photograph of the container using image recognition algorithms.

12. The system of claim 11, wherein the instructions are further configured to:
integrate indoor navigation with the hierarchical inventory, wherein the indoor navigation is configured to guide a user from a current location to a selected container.

13. The system of claim 11, wherein the instructions are further configured to:
render a search interface on a user device, the search interface configured to receive one or more keywords and display corresponding search results.

14. The system of claim 13, wherein the instructions are further configured to:
display the image of the container and the internal photograph of the container in the search results.

15. The system of claim 16, wherein the internal photograph is labeled with the items contained in the container.

16. The system of claim 14, wherein the instructions are further configured to:
interface the indoor navigation with a home automation system to automatically control lighting along a navigation path.
